(19) United States
(12) Patent Application Publication
(10) Pub. No.: US 2005/0199083 A1
(43) Pub. Date: Sep. 15, 2005

(54) Powered actuator for a bicycle gearshift, with a controlled friction mechanism

(75) Inventor: Mario Meggiolan, Creazzo (Vicenza) (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo, S.r.I., Vicenza (IT)

(21) Appl. No.: 11/068,636

(22) Filed: Feb. 28, 2005

(30) Foreign Application Priority Data
Feb. 27, 2004 (EP) 04425127.0

(51) Int. Cl. F16D 55/02

(52) U.S. Cl. 74/473.12

(57) ABSTRACT

The actuator device (100), comprises an articulated quadrilateral mechanism (101) and a motor member (120), having a variable length to deform the articulated quadrilateral (101); the motor member (120) comprises a threaded drive shaft or screw (122) in engagement with a nut (10). According to the invention, the actuator comprises friction control means (40) between the screw (122) and the nut (10), to impede spontaneous accidental movements between them.

### FIELD OF INVENTION

The present invention refers to an actuator for a bicycle gearshift, i.e. to a mechanical device which causes the displacement of the chain between different toothed wheels, for such a purpose displacing a derailleur by which the chain is guided.

### BACKGROUND

In the context of this patent description and of the subsequent claims, the gearshift to which reference is made can indifferently be the rear one, which displaces the chain between the different sprockets associated with the rear wheel of the bicycle, or the front one, which displaces the chain between the different crowns associated with the cranks.

Normally, the actuator device of the gearshift comprises an articulated quadrilateral mechanism (typically an articulated parallelogram mechanism) with four connecting rods hinged together according to four pin axes by four pin elements, in which the first connecting rod is fixed integrally to the bicycle frame, the second connecting rod (opposite the first connecting rod in the articulated quadrilateral) is fixed to a support for the derailleur of the gearshift; the deformation of the articulated quadrilateral determines the displacement of the derailleur and thus the gearshifting.

The aforementioned deformation of the articulated quadrilateral can be obtained with manual actuation, through the movement of control levers transmitted to the actuator through a Bowden cable, or else with powered actuation, thanks to an electric motor which—following a suitable command imparted by the cyclist and through a suitable mechanism—displaces different parts of the articulated quadrilateral with respect to each other, deforming it and thus displacing the derailleur. Actuators with powered actuation are described for example in EP-A-1357023; in them, the mechanism acts by moving opposite pins of the articulated quadrilateral towards and away from each other.

A constant aim of producers of gearshifts is that of improving the precision of actuation, upon which depends the ease and reliability of operation of the gearshift. This requirement is clearly all the more necessary the more the gearshift is intended to be used in high level cycling competitions. The adoption of electric motor members makes such a requirement even more necessary, because the deformation action in such a case is very direct, without the mediation of the Bowden cable.

Furthermore, the attention of the Applicant itself has been focused upon avoiding that in normal use the performance of a gearshift with a powered actuator be jeopardised by even small damage, which are often a non-visible consequence of knocks undergone by the gearshift itself. For such a purpose, it has been provided to insert a preloaded spring in the mechanism, such as to behave like a rigid body up to a certain stress limit (typical of the normal operation of the gearshift) and to elastically yield under anomalous greater stresses, at the same time ensuring the elastic return into the starting position; in this respect, see the co-pending European patent application to the same Applicant n° 03425534.9.

The inventors realised that sometimes the good operation of gearshifts with a powered actuator is disturbed by small displacements in the actuation mechanism that accidentally and spontaneously occur between screw and nut due to vibrations or knocks, above all in transportation step but also during riding, when a gear ratio is stably inserted. The aforementioned displacements alter the calibration conditions of the actuator, making gearshifting difficult if not impossible, unless a new calibration is performed.

The problem at the basis of the present invention is that of avoiding or at least reducing—in a simple and effective manner—the possibility of accidental displacements of the actuation mechanism of a gearshift with powered actuation.

Such a problem is solved with an actuator according to claim 1. Preferred characteristics are indicated in the dependent claims.

### SUMMARY

The present invention concerns an actuator device for a bicycle gearshift, comprising
an articulated quadrilateral mechanism with four connecting rods hinged together by four pin elements, in which the first connecting rod is intended to be fixed integrally to a bicycle frame, the second connecting rod is opposite the first connecting rod in the articulated quadrilateral and is intended to be fixed to a support for a derailleur of the gearshift;
a motor member, having a variable length according to a drive axis and acting between two opposite pin elements to move them towards and away from each other deforming the articulated quadrilateral; in which the motor member comprises an electric motor housed on a support mounted on a first of the pin elements, a screw arranged axially along the drive axis and moved in rotation by the electric motor, a nut in mesh engagement with the screw and fixed to a second of the pin elements opposite the first, characterised in that it comprises friction control means between the screw and the nut.

A controlled friction between screw and nut allows spontaneous accidental movements between them to be impeded and in most cases prevented. Such friction shall preferably be significant but low; by significant it is meant that it has a value sufficiently high as to effectively brake the displacements that can be induced spontaneously between screw and nut due to vibrations to which the bicycle is subjected; by low it is meant that it has a value sufficiently low as not to substantially impede the normal operation of the actuator.

Such friction can be obtained in different ways, for example with surface treatment of the screw and/or of the nut, such as knurling or the like, or else with a friction control material with a predetermined friction coefficient, applied between the screw and the nut.

Preferably, the friction control means comprise an elastic element acting on one of the screw and the nut to angularly force the screw and the nut one with respect to the other. The action of such an elastic element is such as to create local pressure stresses between the screw and the nut, with a consequent increase in friction between them. More preferably said elastic element is a spring, even more preferably a preloaded spring; the preloading of the spring together with its substantially negligible elongation ensures that the pressure between screw and nut is kept substantially constant, so as to ensure friction and therefore a braking effect that are likewise constant.

### DESCRIPTION OF THE EMBODIMENTS

Further characteristics and advantages of the invention shall become clearer from the following description of a preferred embodiment thereof, made with reference to the attached drawings. In such drawings:

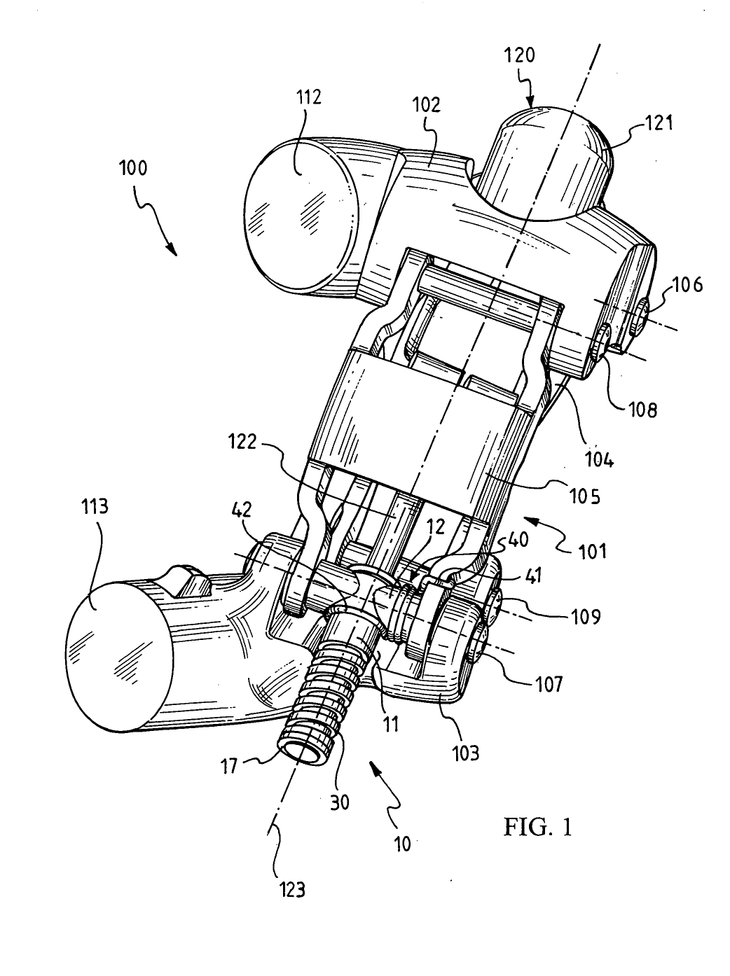

FIG. 1 is a perspective view of an actuator according to the invention;

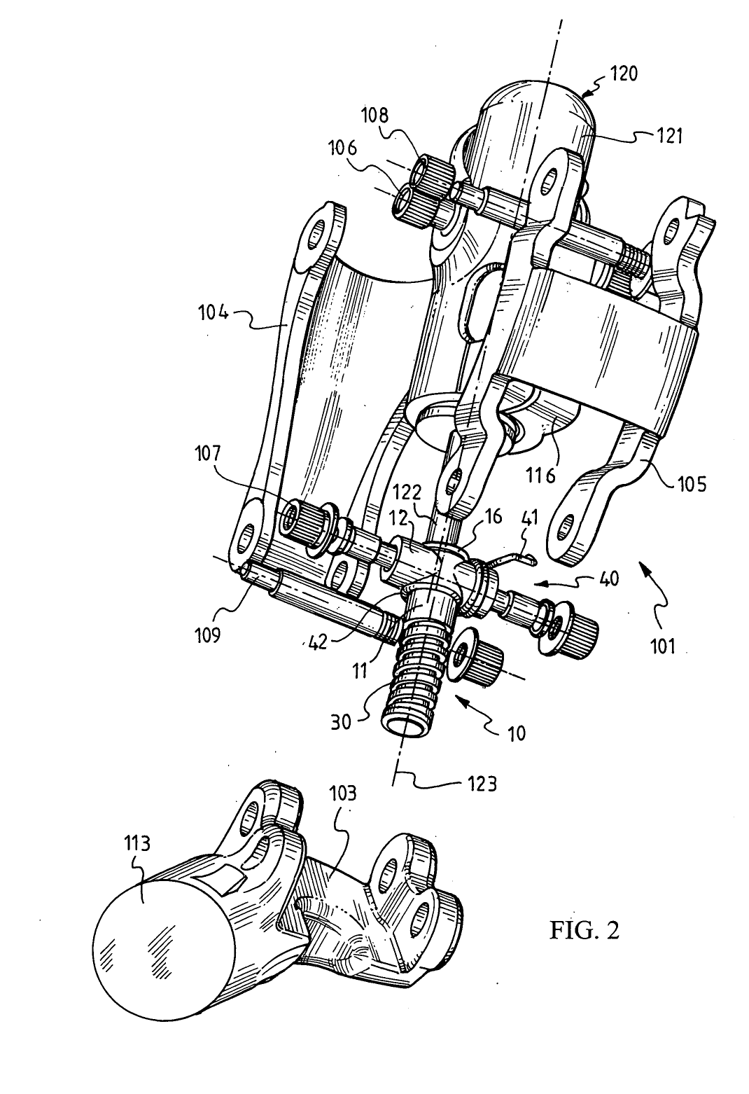

FIG. 2 is an exploded perspective view of some parts of the actuator of FIG. 1;

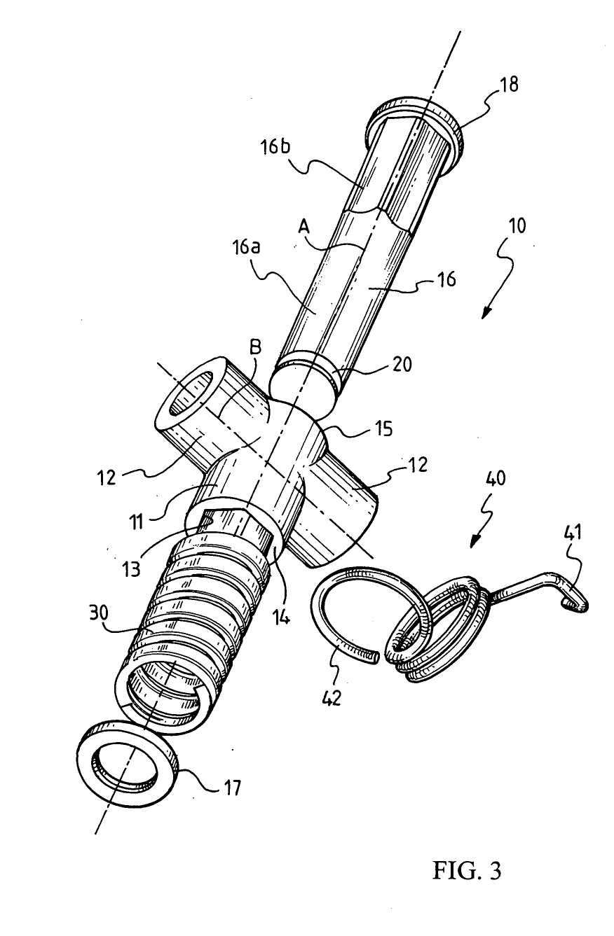

FIG. 3 is an exploded view of a detail of the actuator of FIG. 1.

With particular reference to FIGS. 1 and 2, an actuator device for a bicycle gearshift, particularly a rear gearshift, according to a first embodiment of the invention is indicated with 100.

The device 100 comprises an articulated quadrilateral actuation mechanism 101, more precisely an articulated parallelogram mechanism, intended to be moved by a motor member 120 and in turn to move a normal derailleur (not illustrated) of a rear gearshift of a bicycle. In alternative embodiments (not illustrated) the articulated quadrilateral can be a trapezium instead of a parallelogram.

The mechanism 101 comprises four connecting rods articulated together by four pin elements. The connecting rods comprise a first connecting rod 102 associated with a support 112 for attachment to a bicycle frame, a second connecting rod 103 opposite the first connecting rod 102 and associated with a support 113 for attachment of the derailleur, a third connecting rod 104 and a fourth connecting rod 105. The pin elements comprise a first pin element 106 (between the first and the third connecting rod 102 and 104), a second pin element 107 opposite the first (between the second and the fourth connecting rod 103 and 105), a third pin element 108 (between the first and the fourth connecting rod 102 and 105) and a fourth pin element 109 opposite the third (between the second and the third connecting rod 103 and 104).

A support 116 for the motor member 120 is associated with the first pin element 106. It should be noted that by the term “associated”, referring to the support 116 in relation to the pin element, it is meant here and later on that the member in question is mechanically connected to the pin element, or else is formed integrally with it, or furthermore that such a member is configured in such a way as to be able to carry out the functions of the pin element. The motor member 120 comprises an electric motor 121 (supplied and controlled by means of control cables and members, not illustrated in the figures) provided with a threaded drive shaft (also called screw hereafter) 122, extending along a drive axis 123 and moved in rotation by the motor 121. In the illustrated example, the support 116 is substantially cradle-shaped, so as to be able to house the motor 121 with the drive axis 123 substantially at the axis of the pin 106.

The motor member 120 is coupled with the mechanism 101 by means of a nut 10, in screwing engagement with the screw 122 and associated with the second pin element 107. Through the nut 10 and the support 116, the motor member 120 is able to move the mechanism 101, making the diagonal between the pin elements 106 and 107 longer or shorter.

The nut 10 (better illustrated in FIG. 3) is in accordance with the cited European patent application n° 03425534.9 to the same Applicant; alternatively, a simpler nut can be provided, like for example the one described in the cited EP-A-1357023. The nut 10 comprises a tubular body 11 extending along an axis A and integral with two pin portions 12 that are identical, aligned and opposite to each other, extending along an axis B substantially perpendicular to the axis A. The pin portions 12 are integral with the tubular body 11 or preferably formed integrally with it. The tubular body 11 is provided with an inner recess 13 with a polygonal section, passing through and extending along the axis A between two annular abutment surfaces, a first abutment surface 14 and a second abutment surface 15, formed at opposite ends of the tubular body 11.

The nut 10 also comprises a tubular sleeve 16, threaded internally with an inner threading matching the outer threading of the screw 122, so as to allow mesh engagement between the screw 122 and the nut 10. The sleeve 16 has a portion 16a with an externally circular section and a portion 16b with an externally polygonal section, matching the section of the inner recess 13, so as to allow the sleeve 16 inserted in the recess 13 of the tubular body 11 to be able to slide along the axis A but so that it cannot rotate around such an axis. The sleeve 16 is provided, at its opposite ends, with two projecting abutment collars, a first collar 17 and a second collar 18.

The first collar 17 is in the form of an annular washer, mounted on the circular portion 16a of the sleeve 16, in a respective groove 20 formed circumferentially on the outer surface of the sleeve 16. The second collar 18 is in the form of a projecting circular head of the portion 16b of the sleeve 16.

The nut 10 also comprises a spring 30, inserted on the sleeve 16. In conditions with the nut 10 mounted (FIG. 1), the sleeve 16 is inserted in the tubular body 11, with the second collar 18 abutting against the second abutment surface 15 and with the spring 30 compressed between the first abutment collar 17 and the first abutment surface 14.

The spring 30 illustrated as an example is a helical metal spring; instead of this a tubular elastomeric spring or any other spring capable of applying the same action in the nut 10 could be used.

The choice, sizing and compression of the spring 30 as well as assembly of the nut 10 are carried out depending upon the protective action that the nut 10 must provide inside the actuator device in which it is mounted, according to the teachings of the cited European patent application n° 03425534.9 to the same applicant.

The elastic yield of the nut 10 allows an elongation of the diagonal between the pin elements 106 and 107 even with the motor 121 off (or in any case a different elongation from that which the motor 121 would give). For such a purpose, the nut 10 is mounted by inserting the screw 122 into the sleeve 16 from the side of the second abutment collar 18: a possible knock will thus tend to compress the spring 30, making the sleeve 16 slide in the tubular body 11.

In accordance with the present invention, the mechanism 101 comprises friction control means between the screw 122 and the nut 10. Such means comprise a spring 40, acting between the connecting rod 105 and the nut 10; for such a purpose, the spring 40 comprises an end 41 with which it is hooked to the connecting rod 105 and an end 42 with which it is hooked to the nut 10, on the tubular body 11 thereof.

The spring 40 is preloaded, so as to angularly thrust upon the nut 10 in such direction to tend to make the nut 10 rotate around the axis B (coinciding with the axis of the pin 107), i.e. to tend to put the nut 10 out of alignment with respect to the drive axis 123. The aforementioned thrust of the spring 40 thus causes local pressure stresses between the screw 122 and the threaded sleeve 16 of the nut 10, with a consequent increase in the friction between such elements. The spring 40 is sized and in particular preloaded so that such friction is significant but low (in the sense clarified above). Thanks to this, the possible displacements between the screw 122 and the nut 10 due to possible vibrations to which the actuator 100 might be subjected are avoided or at least reduced.

Instead of the spring 40 that acts on the nut 10, it is possible to provide an analogous spring that acts on the screw 122, i.e. on the motor 120, thrusting it in an angular direction with respect to the axis of the pin 106 on which it is mounted. Given the length of the screw 122, such a solution requires that the used spring applies a much greater force than that required of the spring 40, to obtain the same effect.

As an alternative or in addition to the spring 40, the friction control means between the screw 122 and the nut 10 can comprise a specific surface treatment of the outer threading of the screw 122 and/or inner threading of the sleeve 16 of the nut 10. Such a treatment can, for example, be a stippling or even knurling, on one and/or other of the threadings.

Furthermore, as an alternative or in addition to the spring 40 and/or to the aforementioned surface treatment, the friction control means between the screw 122 and the nut 10 can comprise a special varnishing or resin application on one or both of the threadings; in such a way, in practice, a friction control material is placed between the two threadings.

The invention has been described with reference to a specific application on an actuator 100 for a rear gearshift. However, it is clear that it can equally be implemented on an actuator for a front gearshift, by acting in a totally similar way on the coupling between screw and nut.

1. Actuator device (100) for a bicycle gearshift, comprising
an articulated quadrilateral mechanism (101) with four connecting rods (102, 103, 104, 105) hinged together by four pin elements (106, 107, 108, 109), in which the first connecting rod (102) is intended to be fixed integrally to a bicycle frame, the second connecting rod (103) is opposite the first connecting rod (102) in the articulated quadrilateral (101) and is intended to be fixed to a support (113) for a derailleur of the gearshift;
a motor member (120), having a variable length according to a drive axis (123) and acting between two opposite pin elements (106, 107) to move them towards and away from each other deforming the articulated quadrilateral (101);
wherein the motor member (120) comprises an electric motor (121) housed on a support (116) mounted on a first (106) of the pin elements, a screw (122) arranged axially along the drive axis (123) and moved in rotation by the electric motor (121), a nut (10) in mesh engagement with the screw (122) and fixed to a second (107) of the pin elements opposite the first (106), characterised in that it comprises friction control means (40) between the screw (122) and the nut (10).

2. Device according to claim 1, wherein the friction control means comprise a surface treatment of the screw and/or of the nut.

3. Device according to claim 1, wherein the friction control means comprise a friction control material applied between the screw and the nut.

4. Device according to claim 1, wherein the friction control means comprise an elastic element (40) acting on one of the screw (122) and the nut (10) to angularly force the screw (122) and the nut (10) one with respect to the other.

5. Device according to claim 4, wherein the elastic element (40) acts between the nut (10) and one of said connecting rods (105).

6. Device according to claim 4, wherein the elastic element (40) acts between the motor element (120) and one of said connecting rods.

7. Device according to any one of claim 6, wherein said elastic element is a spring (40).

8. Device according to claim 7, wherein the spring (40) is preloaded.

9. In an actuator device (100) for a bicycle gearshift having an articulated quadrilateral mechanism (101) with connecting rods (102, 103, 104, 105) hinged together by pin elements (106, 107, 108, 109), an electric motor (121), a screw (122) driven by the electric motor (121), and a nut (10) engaged with the screw (122), a tensioning element comprising:
a first portion which engages with the nut (10), a second portion which engages with a portion of the quadrilateral mechanism and an intermediate portion that connects the first and second portions with sufficient force to secure the screw (122) and the nut (10) against spontaneous accidental movement.

10. The tensioning element of claim 9 wherein the force sufficient to secure the screw (122) and the nut (10) against spontaneous accidental movement is a friction force.

11. The tensioning element of claim 10 wherein the force sufficient to secure the screw (122) and the nut (10) against spontaneous accidental movement is a friction force provided by modification of a surface forming the engagement between the nut (10) and the screw (122).

12. The tensioning element of claim 10 wherein the force sufficient to secure the screw (122) and the nut (10) against spontaneous accidental movement is a friction force provided by treatment of a surface forming the engagement between the nut (10) and the screw (122).

13. The tensioning element of claim 12 wherein the force sufficient to secure the screw (122) and the nut (10) against spontaneous accidental movement is a friction force provided by treatment of a surface forming the engagement between the nut (10) and the screw (122) with a friction control material.

14. The tensioning element of claim 9 wherein the force sufficient to secure the screw (122) and the nut (10) against spontaneous accidental movement is a compressive force.

15. The tensioning element of claim 14 wherein the compressive force sufficient to secure the screw (122) and the nut (10) against spontaneous accidental movement is provided by an elastic element.

16. The tensioning element of claim 9 wherein the elastic element securing the screw (122) and the nut (10) against spontaneous accidental movement is a spring.

17. The tensioning element of claim 9 wherein the elastic element is a compressive force sufficient to secure the screw (122) and the nut (10) against spontaneous accidental movement is provided by a spring.

18. A element for controlling spontaneous accidental movement of a bicycle gearshift actuator 100) that has an articulated quadrilateral mechanism (101) with connecting rods (102, 103, 104, 105) hinged together by pin elements (106, 107, 108, 109), an electric motor (121), a screw (122) driven by the electric motor (121), and a nut (10) engaged with the screw (122), the control element comprising an elastic member having:
a first end portion which engages with the nut (10), a second end portion which engages the quadrilateral mechanism (101) and an intermediate force producing portion that produces a force that secures the screw (122) and the nut (10) against spontaneous accidental movement.

19. The control element of claim 18 wherein the intermediate force producing portion that produces a force that secures the screw (122) and the nut (10) against spontaneous accidental movement is selected to be equal to a predetermined force which is sufficient to cause a spontaneous accidental movement.

20. An elastic element for controlling accidental movement of a bicycle gearshift actuator (100) that has an articulated quadrilateral mechanism (101) associated with an electric motor (121) driven screw (122) that engages a nut (10) and the engagement between the screw (122) and the nut (10) to an accidental movement not resulting from a rider's action upon the actuator, the elastic control element comprising:
a first end portion which engages with the nut (10), a second end portion which engages the quadrilateral mechanism (101) and an intermediate force producing portion that produces a force that is substantially equal to the predetermined force and secures the screw (122) and the nut (10) against accidental movement.

21. The elastic element for controlling accidental movement of claim 20 wherein the intermediate force producing portion does not produce a force greater than the predetermined force so that normal operation of the actuator (100) is not impeded by that force.

22. A bicycle gearshift actuator device (100) comprising:
an articulated quadrilateral mechanism (101);
an electric motor (121);
a screw (122) driven by the electric motor (121); and,
a nut (10) associated with the quadrilateral mechanism and having a threaded sleeve (16) in engagement with the screw (122), wherein the screw (122) and the threaded sleeve (16) of the nut (10) having engaging portions which include knurling that produces sufficient force to hold the screw (122) against the nut (10) and prevent spontaneous accidental movement.

23. A bicycle gearshift actuator device (100) comprising:
an articulated quadrilateral mechanism (101);
an electric motor (121);
a screw (122) driven by the electric motor (121);
a nut (10) connected to the quadrilateral mechanism (101) and having a threaded sleeve (16) that engages with the screw (122) with a predetermined friction force; and,
an elastic element that urges the screw (122) against the threaded sleeve (16) of the nut (10), increases the predetermined friction force and prevents accidental movement between them.

24. A bicycle gearshift actuator device (100) comprising:
an articulated quadrilateral mechanism (101) with connecting rods (102, 103, 104, 105) hinged together by pin elements (106, 107, 108, 109);
an electric motor (121);
a screw (122) driven by the electric motor (121); and,
a nut (10) having a threaded sleeve (16) in engagement with the screw (122), wherein the screw (122) and the threaded sleeve (16) of the nut (10) having engaging portions which include knurling that produces sufficient force to hold the screw (122) against the nut (10) and prevent spontaneous accidental movement.

25. Actuator device (100) for a bicycle gearshift, comprising
an articulated quadrilateral mechanism (101) with four connecting rods (102, 103, 104, 105) hinged together by four pin elements (106, 107, 108, 109), in which the first connecting rod (102) is intended to be fixed integrally to a bicycle frame, the second connecting rod (103) is opposite the first connecting rod (102) in the articulated quadrilateral (101) and is intended to be fixed to a support (113) for a derailleur of the gearshift;
a motor member (120), having a variable length according to a drive axis (123) and acting between two opposite pin elements (106, 107) to move them towards and away from each other deforming the articulated quadrilateral (101);
wherein the motor member (120) comprises an electric motor (121) housed on a support (116) mounted on a first (106) of the pin elements, a screw (122) arranged axially along the drive axis (123) and moved in rotation by the electric motor (121), a nut (10) in mesh engagement with the screw (122) and fixed to a second (107) of the pin elements opposite the first (106),
characterised in that it has a friction control means (40) between the screw (122) and the nut (10) comprising a spring element (40) acting between one of said connecting rods (105) and the nut (10) to angularly force the screw (122) and the nut (10) one with respect to the other.

26. Device according to claim 1, wherein the friction control means comprise a spring (40) acting on one of the screw (122) and the nut (10) to angularly force the screw (122) and the nut (10) one with respect to the other.

27. Device according to claim 26, wherein the spring (40) acts between the nut (10) and one of said connecting rods (105).

28. Device according to claim 26, wherein the spring (40) acts between the motor element (120) and one of said connecting rods.

29. Device according to claim 1, wherein said friction control means (40) is a spring.
